(19) United States
(12) Patent Application Publication
(10) Pub. No.: US 2007/0180399 A1
(43) Pub. Date: Aug. 2, 2007

(54) Method and system for scrolling information across a display device

(75) Inventor: Philip M. Htoon, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/344,744

(22) Filed: Jan. 31, 2006

(51) Int. Cl. G06F 3/048

(52) U.S. Cl. 715/786

(57) ABSTRACT

A display device for displaying text comprises an information display area and an information scrawl area. The information display area is configured to display a display page of information selected from a set of display pages of information. The information scrawl area is configured to display a message whose message content is based, at least in part, on the display page of information displayed in the information display area and the content of a scrawl database.

### FIELD OF THE INVENTION

The present invention generally relates to the field of display systems and, in particular, to a method and system for scrolling information across a display device.

### BACKGROUND OF THE INVENTION

Display systems are used to provide a visual feedback to one or more operators. For example, modem aircraft can include one or more display units for displaying information to the flight crew and/or maintenance personnel. The display units have a display area for displaying the information. Often, the amount of information to be displayed is greater than the display area. As a result, the information may be divided between multiple display pages. Typically, specific display pages display specific designated information. One drawback to this approach is that a user may have to maneuver through several display pages to view specific information. This can be especially burdensome if the operator's attention needs to be focused on other tasks. For example, paging through multiple display pages can take time away from a pilot's other duties.

Accordingly, it is desirable to provide a method and system for scrolling information across a display device. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In one embodiment of the present invention, a display device for displaying text comprises an information display area and an information scrawl area. The information display area is configured to display a display page of information selected from a set of display pages of information. The information scrawl area is configured to display a message, the content of the message associated with the display page of information displayed in the information display area and the content of the message comprising information from the set of display pages of information not displayed in a current display page.

In another embodiment of the present invention, a method for displaying messages on a display is provided. In a first step, a current display page of information from a set of display pages of information to be displayed in an information display area is associated with scrawl information to be displayed in the information scrawl area. The scrawl information is not contained in the current display page of information pages. Next, the association between the display pages and the set of information and data is stored in a database. Then, the current display page from the set of display pages of information is displayed in the information display area. Next, the set of data and information associated with the current display page is retrieved from the database. Finally, the set of data and information is displayed as one or more messages in the information scrawl area.

A system for displaying messages in an information scrawl area of a display comprises a display processor configured to generate commands to display multiple display pages of information and a scrawl area generator configured to generate one or messages from a set of data and information. A display, including an information display area and an information scrawl area, is coupled to the display processor and is configured, in response thereto, to display a current display page of information from the multiple display pages of information in an information display area and configured to display the one or more messages in the information scrawl area. The content of the one or more messages is determined, at least in part, by the current display page of information displayed in the information display area and the content of the message comprising information not displayed in the current display page of information.

### BRIEF DESCRIPTION OF THE DRAWINGS

The present invention will hereinafter be described in conjunction with the following drawing figures, wherein like numerals denote like elements, and:

FIG. 1 illustrates an exemplary display in accordance with the teachings of the present invention;

FIG. 2 illustrates an alternative exemplary embodiment of display 100 in accordance with the teachings of the present invention;

FIG. 3 illustrates a exemplary system for displaying moving text in accordance with the teachings of the present invention;

FIG. 4 is a flow chart of a method for creating a scrawl database in accordance with the teachings of the present invention; and

FIG. 5 is a flow chart of a method for displaying moving text on a display in accordance with the teachings of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

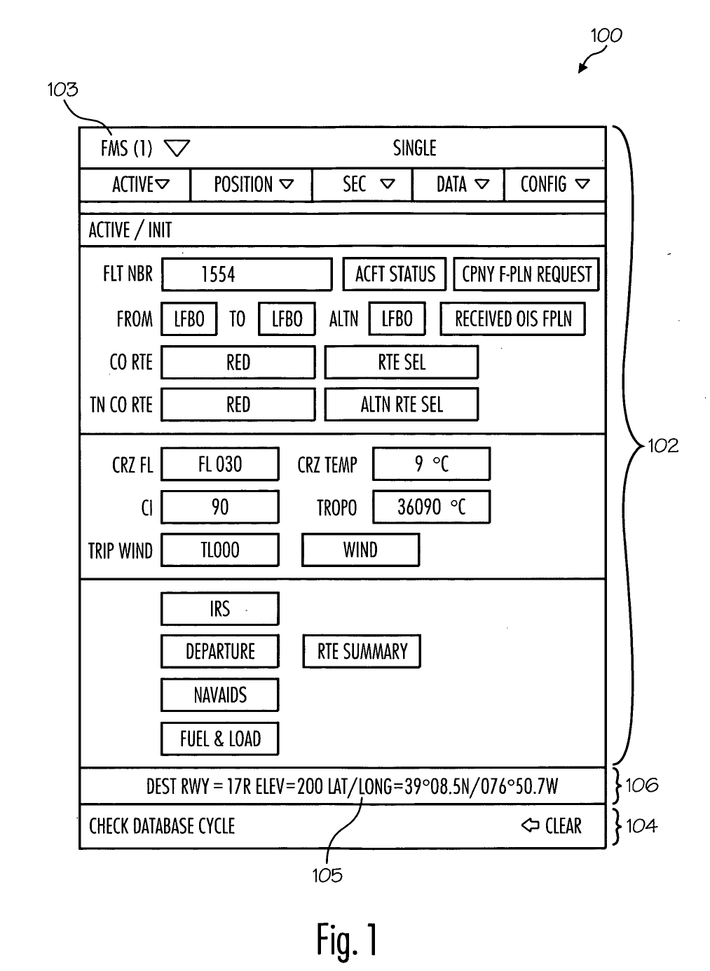

FIG. 1 illustrates an exemplary display 100 in accordance with the teachings of the present invention. Display 100 comprises an information area 102, a scratch pad area 104, and an information scrawl area 106.

Display 100 can be any one of numerous devices capable of displaying textual and/or graphical information such as a liquid crystal display, a cathode ray tube display, an organic light emitting diode display and the like. In one exemplary embodiment, display 100 can be an avionics display capable of displaying flight management system information, such as the flight number, flying altitude, and the like. The information is displayed in information area 102 of display 100. In a typical embodiment, the information area 102 is too small to display all necessary data and information. To alleviate this problem, the data and information is divided into a number of display pages 103 that can be displayed one display page 103 at a time in the information area 102. Typically, each display page 103 displays specifically designated information. A user of the display 100 can switch between display pages 103 using, in one exemplary embodiment, a point and click device such as a computer mouse or trackball. As discussed previously, locating data and information contained on different display pages 103 can be time consuming and distracting to an operator of the display 100.

Scratch pad area 104 displays textual information entered by the operator. For example, in one embodiment of the present invention, a pilot may need to enter flight information. As the text is entered by the pilot using a device such as a keyboard (not pictured), the scratch pad area 104 displays the entered text for visual verification purposes.

Information scrawl area 106 is an area on the display 100 where messages 105 comprising data and information can be displayed to an operator of the display 100. In a typical embodiment, the messages 105 are displayed by moving the message 105 across the information scrawl area 106 beginning at the right side of the information scrawl area 106, with the characters of the message 105 moving to the left and disappearing at the left side of the information scrawl area 106. The same message 105 may then start to move again at the right side of the information scrawl area 106 or other messages can begin to move across the information scrawl area 106. The moving message 105 thus scrolls or scrawls across the information scrawl area 106, similar to the text of a stock ticker as seen on television.

In addition to moving right to left, the message 105 could also move from left to right and could start at any place within the information scrawl area 106. Also, the information scrawl area 106 can be vertically aligned allowing for top to bottom scrawling or bottom to top scrawling. Also, instead of scrolling message 105, the message 105 can be displayed in the information scrawl area 106 by flashing the text of the message 105 and then displaying a blank information scrawl area 106. By repeatedly flashing the text of the message 105, the message 105 being displayed can be highlighted to a user of the display 100. While information scrawl area 106 is shown near the bottom of display 100, the information scrawl area 106 can be in any convenient location on display 100. Further, in one exemplary embodiment, the information scrawl area 106 supports one line of textual characters. However, the information scrawl area 106 can support multiple lines of characters.

In one exemplary embodiment of the present invention, the color of the text message 105 can be varied. For example, messages 105 containing information of a normal priority can be displayed as white text. Emergency information can be displayed as amber or red text. Other text color coding schemes can also be utilized.

In one exemplary embodiment, messages can be displayed repeatedly, by moving the message across the information scrawl area 106. Alternatively, the length of time or number of times a message is displayed can be predetermined.

In one exemplary embodiment, the content of the messages displayed in the information scrawl area 106 is based on the information of the display page 103 that is currently shown in the information area 102. For example, if the information area 102 is displaying information related to the flight management system, information, data and information not currently shown in the information area 102 can be displayed as messages 105 in the information scrawl area 106. The information display as messages can be contained in display pages 103 not currently displayed in the information display area 102 or can be any other information or data, not currently displayed in the information display area 102, such as alert messages and the like. By displaying messages that can include information and data from non-displayed display pages 103, the amount of time spent on manipulating the display pages 103 can be reduced for the user of the display 100. Additionally, displaying information that does not appear on any of the display pages 103 allows additional important information to be provided to the user of the display 100 that might not otherwise be easily displayed.

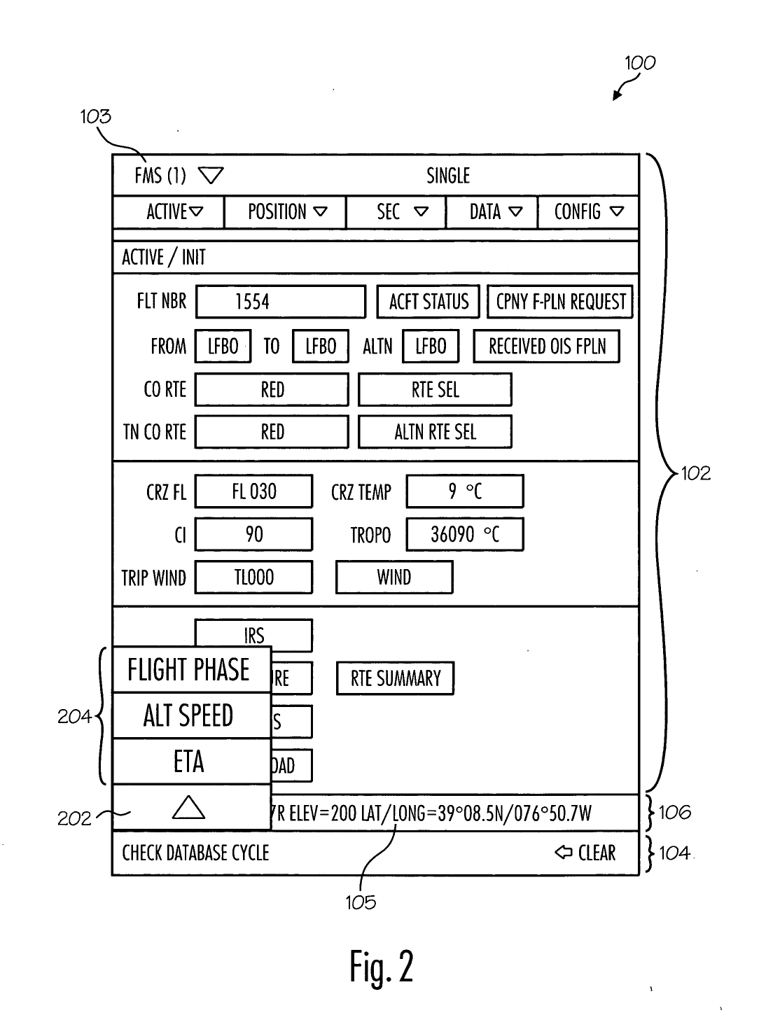

FIG. 2 illustrates an alternative exemplary embodiment of display 100 in accordance with the teachings of the present invention. In this exemplary embodiment, instead of moving a series of messages across information scrawl area 106, a message selection icon 202 can be provided that, when selected, can show a number of message identifiers 204. For example, the message identifiers 204 may include a list of messages 105 that can be displayed on information scrawl area 106. The user can then select one of the message identifiers 204 to cause a message 105 related to the message identifier 204 to be displayed in, and move across, the information scrawl area 106.

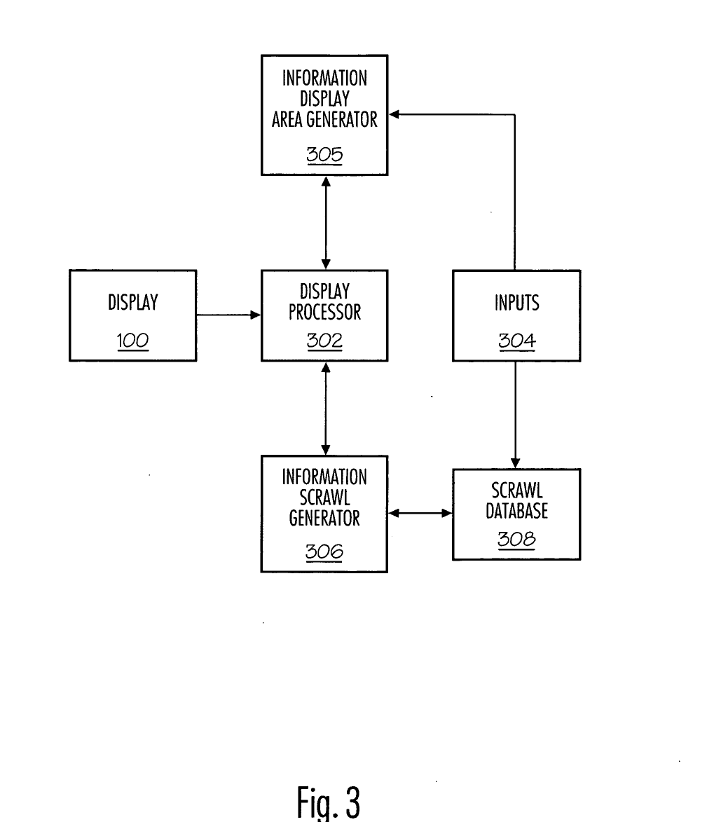

FIG. 3 illustrates a system 300 for displaying moveable text on a display, such as message 105 on display 100. System 300 includes display 100, which is coupled to a display processor 302. Display processor 302 is coupled to an information display area generator 305 and an information scrawl area generator 306. A scrawl database 308 is coupled to the information scrawl area generator 306 and the display input data 304. System inputs 304 are coupled to the information display area generator 305 and the scrawl database 308.

The display processor 302 receives various inputs and generates appropriate display commands that are sent to the display 100 to generate images on the display 100. In one exemplary embodiment, system inputs 304, such as aircraft speed and heading, are received by the information display area generator 305. The information display area generator 305 organizes the input data 304 into the display pages 103 to be shown in the information display area 102. In one exemplary embodiment, the organization of the data and information is predetermined and the content of each display page 103 is predefined. The display processor 302 can then prepare the commands necessary to display that information on the display 100. Display processor 302 can be any processor capable of interfacing with a display to produce an image on the display 100.

Information scrawl area generator 306 determines the information and data to be used as the content of the messages 105 that are displayed in the information scrawl area 106 and provides the information and data to the display processor 302. In one exemplary embodiment, the content of the messages 105 displayed in information scrawl area 106 is associated with information being shown in the information area 102. For example, each of the display pages 103 that can be displayed in the information area 102 can be pre-associated with data and information that can be the content of the messages 105. These messages 105 can then be displayed in the information scrawl area 104. In one exemplary embodiment, the scrawl database 308 can store the association between each page of information that can be displayed in the information area 102 with predetermined information and data to be displayed in the information scrawl area 106. The scrawl database 308 can also include an indicator of how long or how often a message is to be displayed. For example, for certain data associated with a display page the message may continually repeat until a new display page is selected. Alternatively, a message may only display once. The configurability of the scrawl database 308 allows these parameters to be selected. Also, the configurability of the scrawl database 308 allows different associations of data with display pages for different applications. Currently, display pages and their layouts are predetermined and used for different airlines. The configurability of the scrawl database 308 allows for different airlines to select the messages 105 they want displayed.

In an exemplary avionics embodiment, display 100 can be an avionics display for a flight management system. In this exemplary embodiment, before an aircraft takes-off, the pilot performs a preflight check-off procedure. Typically, this involves the pilot moving through several different pages of information displayed on the display 100. In the present invention, upon start of the preflight check-off, an initial display page 103 is started. The scrawl generator 306 determines the current display page 103 and the information and data to use as the content of the message 105 to be displayed in the information scrawl area 106. This message 105 can comprise information needed by the pilot for the preflight check-off that is not shown on the current display page 103. This allows the pilot to more efficiently to complete the preflight check list.

In addition to associating pages of information with data to be displayed in the information scrawl area 106, the scrawl database 308 can also include information and data to be displayed associated with the occurrence of an event. For example, in an avionics embodiment, certain messages 105 might be displayed in the information scrawl area 106 when the aircraft is taking-off, making an approach to an airport, and the like.

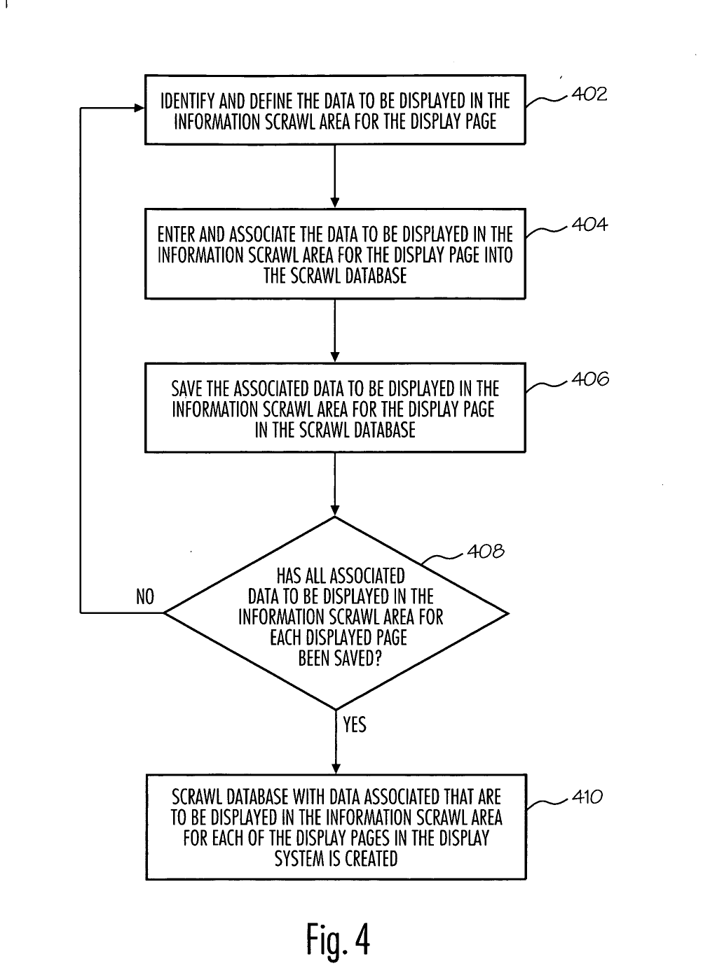

FIG. 4 is a flowchart of a method for creating a scrawl database 308. In a first step, step 402, the data to be displayed in the information scrawl area 106 for each display page 103 is identified and defined. As discussed previously, the data to be displayed in the information scrawl area 106 comprises information not already displayed in a current display page 103. In one exemplary embodiment, the data to be displayed could be found on a display page 103 that is not currently being displayed or the data could be obtained from some other system input 304.

Once the data to be displayed is identified and defined, the data to be displayed is associated with the display page 103 and the association between the display page 103 and the data to be displayed in the information scrawl area 106 is entered into the scrawl database 308 in step 404. In step 406, the associated data to be displayed in the information scrawl area 106 and display page 103, determined in step 404, is stored in the scrawl database 308.

In step 408, it is determined if all data to be displayed in the information scrawl area has been associated with a display page 103 and saved. If there is more data to be associated with display pages 103, then the method starts over at step 402. If all data has been associated with one or more display pages 103, then, in step 410, the scrawl database 308 is complete.

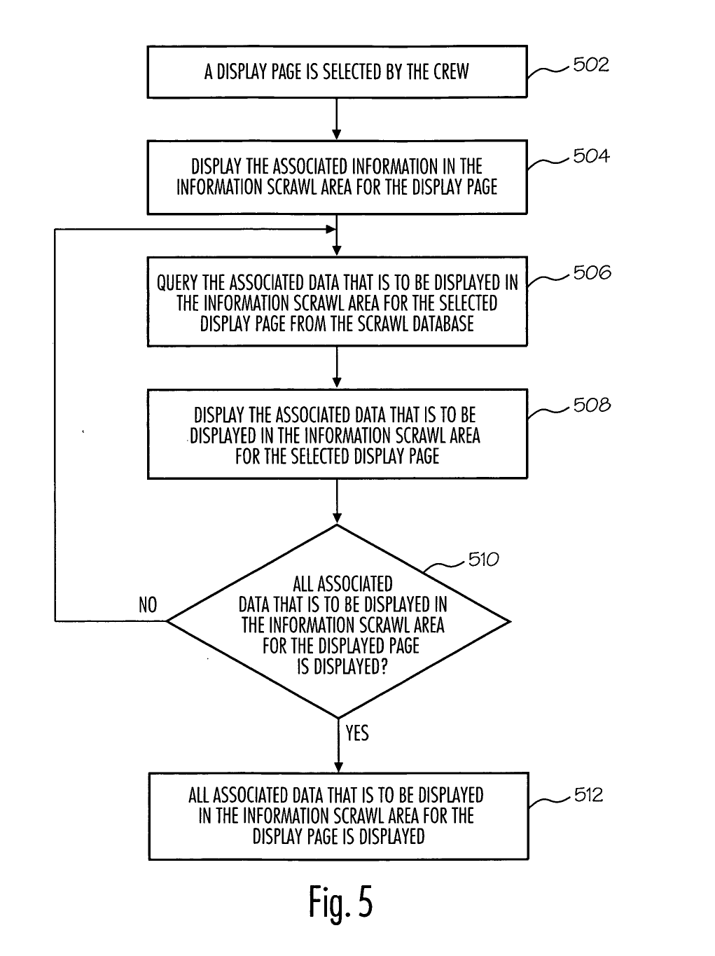

FIG. 5 is a flowchart of an exemplary embodiment for displaying information and data in an information scrawl area 106. In a first step, step 502, a display page is chosen by a member of the flight crew. In one embodiment an initial page may be automatically initialized upon a system start-up. Then, in step 504, the information display page is displayed in the information display area.

Next, in step 506, the scrawl database 308 is queried to retrieve any data associated with the current display page 103. In step 508, the data retrieved in the query is displayed in the information scrawl area 106 as one or more messages 105.

Then, in step 510, it is determined if all data to be displayed in the information scrawl area 106 has been retrieved. If not all data has been retrieved, the process returns to step 506 to retrieve additional data from the scrawl data base 308. If all data has been retrieved, then in step 512, the retrieved data is displayed in the information scrawl area 106. In one exemplary embodiment, the retrieved data is displayed in the information display area 106 for a set number of times, for a set time period, until a predetermined event and the like.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A display device for displaying text comprising:
an information display area for displaying a current display page of information selected from a set of display pages; and
an information scrawl area for displaying a message, the content of the message associated with the current display page of information displayed in the information display area and wherein the message includes content not displayed in the current display page.

2. The display device of claim 1 wherein the message moves across the information scrawl area.

3. The display device of claim 1 further comprising a scratch pad area for providing visual feedback of text entry.

4. The display device of claim 1 wherein the display device is used on an aircraft to display avionic information.

5. The display device of claim 4 wherein the avionics information comprises information and data concerning the flight management system.

6. The display device of claim 1 wherein the message content is selected, at least in part, by the occurrence of an event.

7. The display device of claim 1 wherein the information scrawl area further comprises a selection icon configured to display a list of messages that can be displayed in the information scrawl area.

8. The display device of claim 1 wherein the message comprises color coded text.

9. A method for displaying messages on a display comprising:
associating each display page of information from a set of display pages of information to be displayed in an information display area with scrawl information to be displayed in the information scrawl area, the scrawl information not contained in the current display page of information;
storing the association between each display page and the scrawl information in a database;
selecting a current display page from the set of display pages of information for display in the information display area;
retrieving the scrawl information associated with the current display page; and
displaying the scrawl information as one or more messages in the information scrawl area.

10. The method of claim 9 wherein the step of displaying the scrawl information further comprises moving the message across the information scrawl area.

11. The method of claim 9 further comprising:
displaying a list of messages in the information scrawl area; and
displaying one of the messages in the list upon selection by a user.

12. The method of claim 9 further comprising displaying a visual confirmation in a scratch pad area of text information entered by a user.

13. A system for displaying messages in an information scrawl area of a display comprising:
a display processor configured to generate commands to display multiple display pages of information one display at a time;
a scrawl area generator coupled to the display processor and configured to generate one or more messages from a set of data and information;
a display including an information display area and a information scrawl area, the display coupled to the display processor and configured, in response thereto, to display a current display page of information from the multiple display pages of information in the information display area and configured to display the one or more messages in the information scrawl area; and
wherein content of the one or more messages is associated with, at least in part, the current display page of information displayed in the information display area and the content of the message containing information not displayed in the current display page of information.

14. The system of claim 13 wherein the one or more messages move across the information scrawl area.

15. The system of claim 13 further comprising a scratch pad area for providing visual feedback of text entry.

16. The system of claim 13 wherein the display is used on an aircraft to display avionic information.

17. The system of claim 16 wherein the avionics information comprises information and data concerning the flight management system.

18. The system of claim 13 wherein content of the one or more messages is selected, at least in part, by the occurrence of an event.

19. The system of claim 13 wherein the information scrawl area further comprises a selection icon configured to display a list of messages that can be displayed in the information scrawl area.

20. The system of claim 13 wherein the message comprises color coded text.
